(19) United States
(12) Patent Application Publication
(10) Pub. No.: US 2021/0264477 A1
(43) Pub. Date: Aug. 26, 2021

(54) DETERMINING A NEXUS SCORE OF PHYSICAL ASSETS USING DATA ANALYSIS

(71) Applicant: International Business Machines Corporation, Armonk, NY (US)

(72) Inventors: Stan K. Daley, Atlanta, GA (US); Michael Bender, Rye Brook, NY (US); Gordan G. Greenlee, Endicott, NY (US)

(21) Appl. No.: 16/801,914

(22) Filed: Feb. 26, 2020

(51) Int. Cl. G06Q 30/02

(52) U.S. Cl. CPC G06Q 30/0278

(57) ABSTRACT

A disposition system in which a location and description of a physical asset can be tracked to allow for a future change in ownership, as well as an impartial valuation of the physical asset relative to a nexus of the possible new owners with the physical asset and/or the owner of the physical asset. The disposition system securely values physical assets based on inputted events.

### BACKGROUND

The present invention relates to physical assets, and more specifically to determining a value of a physical asset relative to identified individuals, groups of individuals, an entity or group of entities, and providing a recommendation regarding allocation of the physical asset to the identified individuals, group of individuals, entity or group of entities.

A physical asset is an item of economic, commercial, or exchange value that has a material existence. Physical assets are also known as tangible assets. In terms of business, physical assets can refer to properties, equipment, inventory, and patents.

Physical assets can be owned by an individual or group of individuals, an entity or a group of entities. Entities can include, but are not limited to: companies, foundations, estates, organizations, institutions, universities and other organized groups of people.

Physical assets need to be tracked and valued at certain points in time, and the value needs to be determined based on a trusted, impartial source. Ownership of physical assets can change. For example, the physical asset can be gifted from an owner to another individual, from an owner to a group of individuals, from an owner to an entity, or from an owner to a group of entities. The ownership of the physical assets can also change due to other events, such as entry of a new individual to a group, status change of an owner, disbanding of a group of individuals or group of entities, an owner leaving a group, an owner being unavailable, destruction of a physical asset or theft of a physical asset.

While financial valuations are easily applied to or can be systematically applied to some assets, other assets are more difficult to evaluate and express a value for. The valuation of physical assets may be necessary for taxation purposes, insurance purposes, as well as distribution of assets when an owner or entity is no longer available (i.e. distribution to one or more beneficiaries) or has left a group of individuals or a group of entities or an entity.

With different entities and individuals valuing an owner's physical assets differently, determining a valuation and/or distribution of the physical assets is not easily determined.

### SUMMARY

According to one embodiment of the present invention, a method of receiving and classifying physical assets of an owner. The method comprising: a computer receiving a catalogue of owned physical assets with associated metadata from the owner of the physical asset; the computer receiving allocation rules with classification criteria to be applied to the owned physical assets of the catalogue, wherein the allocation rules include at least an identification of individuals and/or entities to receive at least one of the owned physical assets; the computer applying allocation rules and classification criteria to the catalogue of physical assets received to generate a metadata tiered classification model of the physical assets; the computer determining a value of each of the physical assets of the catalogue; and the computer determining a recommendation for distribution of the physical assets to the identified individuals and entities other than the owner of the physical asset.

According to another embodiment of the present invention, a method of determining a recommendation for allocation of a physical asset of an owner to identified individuals and entities other than the owner of the physical asset, based on an event which impacts a right to use the physical asset by the owner is disclosed. The method comprising: a computer receiving input regarding the event; the computer determining at least one physical asset affected by the event; the computer reevaluating a value associated with the physical asset relative to the event; and the computer determining a recommendation of distribution of the physical assets to the identified individuals and entities other than the owner of the physical asset.

According to another embodiment of the present invention, a computer program product for receiving and classifying physical assets of an owner with a computer is disclosed. The computer comprising at least one processor, one or more memories, one or more computer readable storage media, the computer program product comprising a computer readable storage medium having program instructions embodied therewith. The program instructions executable by the computer to perform a method comprising:

receiving, by the computer, a catalogue of owned physical assets with associated metadata from the owner of the physical asset; receiving, by the computer, allocation rules with classification criteria to be applied to the owned physical assets of the catalogue, wherein the allocation rules include at least an identification of individuals and/or entities to receive at least one of the owned physical assets; applying, by the computer, allocation rules and classification criteria to the catalogue of physical assets received to generate a metadata tiered classification model of the physical assets; determining, by the computer, a value of each of the physical assets of the catalogue; and determining, by the computer, a recommendation for distribution of the physical assets to the identified individuals and entities other than the owner of the physical asset.

According to another embodiment of the preset invention, a computer program product for determining a recommendation for allocation of a physical asset of an owner to identified individuals and entities other than the owner of the physical asset, based on an event which impacts a right to use the physical asset by the owner is disclosed. The computer comprising at least one processor, one or more memories, one or more computer readable storage media, the computer program product comprising a computer readable storage medium having program instructions embodied therewith. The program instructions executable by the computer to perform a method comprising: receiving, by the computer, input regarding the event; determining, by the computer, at least one physical asset affected by the event; reevaluating, by the computer, a value associated with the physical asset relative to the event; and determining, by the computer, a recommendation of distribution of the physical assets to the identified individuals and entities other than the owner of the physical asset.

According to an embodiment of the present invention, a computer system for receiving and classifying physical assets of an owner is disclosed. The computer system comprising a computer comprising at least one processor, one or more memories, one or more computer readable storage media having program instructions executable by the computer to perform the program instructions. The program instructions comprising: receiving, by the computer, a catalogue of owned physical assets with associated metadata from the owner of the physical asset; receiving, by the computer, allocation rules with classification criteria to be applied to the owned physical assets of the catalogue, wherein the allocation rules include at least an identification of individuals and/or entities to receive at least one of the owned physical assets; applying, by the computer, allocation rules and classification criteria to the catalogue of physical assets received to generate a metadata tiered classification model of the physical assets; determining, by the computer, a value of each of the physical assets of the catalogue; and determining, by the computer, a recommendation for distribution of the physical assets to the identified individuals and entities other than the owner of the physical asset.

According to an embodiment of the present invention, a computer system for determining a recommendation for allocation of a physical asset of an owner to identified individuals and entities other than the owner of the physical asset, based on an event which impacts a right to use the physical asset by the owner is disclosed. The computer system comprising a computer comprising at least one processor, one or more memories, one or more computer readable storage media having program instructions executable by the computer to perform the program instructions. The program instructions comprising: receiving, by the computer, input regarding the event; determining, by the computer, at least one physical asset affected by the event; reevaluating, by the computer, a value associated with the physical asset relative to the event; and determining, by the computer, a recommendation of distribution of the physical assets to the identified individuals and entities other than the owner of the physical asset.

### BRIEF DESCRIPTION OF THE DRAWINGS

FIG. 1 depicts an exemplary diagram of a possible data processing environment in which illustrative embodiments may be implemented.

FIG. 2 illustrates internal and external components of a client computer and a server computer in which illustrative embodiments may be implemented.

FIG. 3 shows a flow diagram of a method of receiving and classifying physical assets of an owner of an embodiment.

FIG. 4 shows a flow diagram of a method of providing a disposition allocation recommendation based on an event of an embodiment.

FIG. 5 shows a flow diagram of a method of step 208 of FIG. 3 of generating a nexus score.

FIG. 6 shows a flow diagram of a method of receiving and classifying physical assets of an owner of another embodiment

FIG. 7 shows a flow diagram of a method of providing a disposition allocation recommendation based on an event of another embodiment.

### DETAILED DESCRIPTION

In an embodiment of the present invention, it will be recognized that a location and description of a physical asset can be tracked to allow for a future change in ownership of a physical asset, as well as an impartial valuation of the physical asset at different points of the life cycle that cannot be manipulated. In another embodiment, the physical assets are evaluated relative to a nexus of the possible new owners and value of the physical asset to the each of the possible new owners.

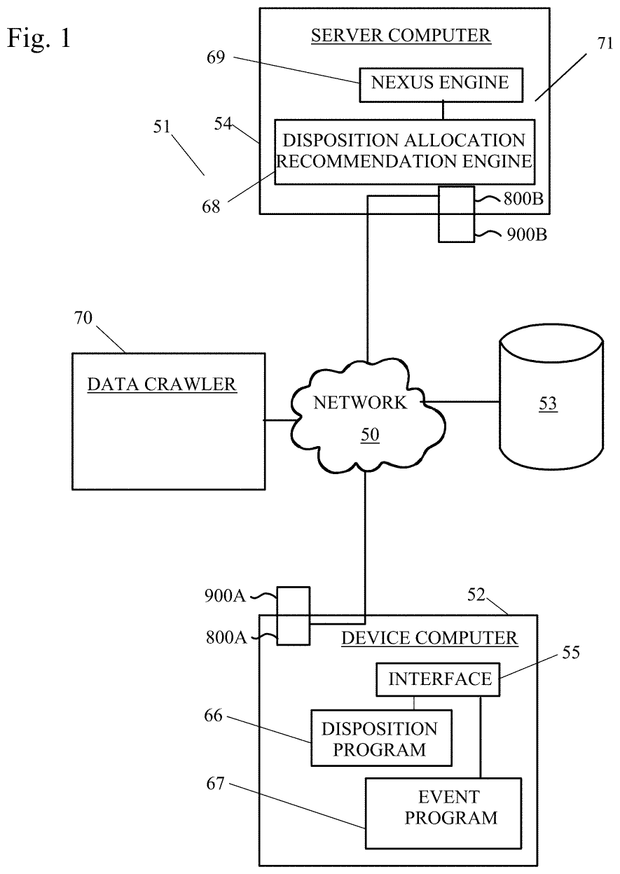

FIG. 1 is an exemplary diagram of a possible data processing environment provided in which illustrative embodiments may be implemented. It should be appreciated that FIG. 1 is only exemplary and is not intended to assert or imply any limitation with regard to the environments in which different embodiments may be implemented. Many modifications to the depicted environments may be made.

Referring to FIG. 1, network data processing system 51 is a network of computers in which illustrative embodiments may be implemented. Network data processing system 51 contains network 50, which is the medium used to provide communication links between various devices and computers connected together within network data processing system 51. Network 50 may include connections, such as wire, wireless communication links, or fiber optic cables.

In the depicted example, device computer 52, a repository 53, a data crawler 70, and a server computer 54 connect to network 50. In other exemplary embodiments, network data processing system 51 may include additional client or device computers, storage devices or repositories, server computers, and other devices not shown.

The device computer 52 may contain an interface 55, which may accept commands and data entry from an owner or other user. The commands may be regarding physical assets, data associated with the physical assets, classification of the physical assets according to preset rules or schemes, allocation rules associated with the physical assets, associated beneficiaries of the physical assets, and events relating to the owner of the physical assets. The interface can be, for example, a command line interface, a graphical user interface (GUI), a natural user interface (NUI) or a touch user interface (TUI). The device computer 52 preferably includes a disposition program 66 and an event program 67.

The disposition program 66 can receive owner entered metadata regarding physical assets, images of the physical assets that preferably show condition and any qualifiers relating to authenticity of the physical asset, allocation of such physical assets, allocation rules and any weights associated with the physical assets. The disposition program 66 can additionally apply a designated classification system to the metadata and associated assets. The disposition program 66 can provide input to a nexus engine 69 described below. The disposition program 66 can receive a report regarding a disposition allocation recommendation of physical assets to identified individuals or entities.

The event program 67 can receive events and determine whether the events are applicable to a single owner or entity, or to a group of owner and/or entities. The event program 67 can also in some cases verify the event and associated consequences of the event. The event program 67 can provide and receive input from the data crawler 70. The event program 67 can interact with, to receive or provide input to, the nexus engine 69 and the disposition allocation recommendation engine 68.

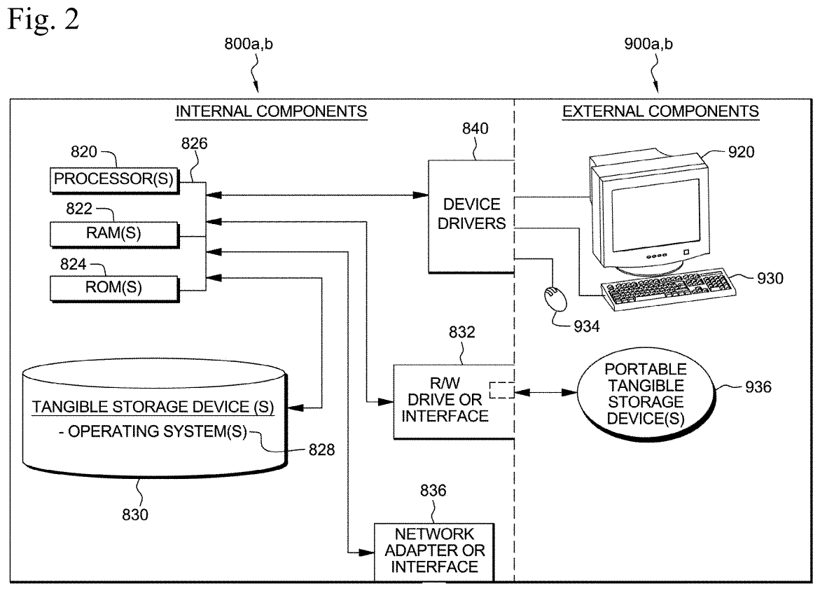

While not shown, it may be desirable to have the disposition program 66 and/or the event program 67 be present on the server computer 54. The device computer 52 includes a set of internal components 800a and a set of external components 900a, further illustrated in FIG. 2.

Server computer 54 includes a set of internal components 800b and a set of external components 900b illustrated in FIG. 2. The server computer can be a directory server. The server computer 54 preferably includes a disposition allocation recommendation engine 68 and a nexus engine 69.

The nexus engine 69 can receive input from data crawler 70, event program 67 and the disposition program 66. The nexus engine 69 calculates and determines a nexus score for each physical asset. The nexus engine 69 can additionally equate a nexus score with a value of the asset relative to a user, a group of users, an entity, or a group of entities that may assume ownership of the physical asset due to an event. The nexus engine 69 can provide input to the disposition allocation recommendation engine 68. In an alternate embodiment, the disposition allocation recommendation engine 68 could equate a nexus score with a value of the asset relative to a user, a group of users, an entity, or a group of entities that may assume ownership of the physical asset due to an event.

The disposition allocation recommendation engine 68 generates and outputs a recommendation to an owner of a physical asset or a third party regarding allocation of the physical assets. The recommendation can be sent to the owner, a third party or a prospective, or to-be owner via the disposition program 66. The disposition allocation recommendation engine 68 can receive input from the nexus engine 69, the disposition program 66 and the event program 67.

In the depicted example, server computer 54 provides information, such as boot files, operating system images, and applications to the device computer 52. Server computer 54 can compute the information locally or extract the information from other computers on network 50. The server computer 54 may contain the event program 67 and/or the disposition program 66.

The disposition program 66, the event program 67, the disposition allocation recommendation engine 68 and the nexus engine 69 are all part of a disposition system 71.

The disposition system 71 can additionally include a data crawler 70 with access to published, public information and records; a report builder; and a secure repository, such as repository 53 which employs security such as, but not limited to blockchain, encrypted keys or hashes. While the repository 53 is shown separately from the server computer 54, the server computer 54 can be a directory server in which a change log remains in persistence within a blockchain. The data crawler 70 can additionally access market to market values of items, auctions of items, and provenance information associated with items.

The data crawler 70, while shown separately in FIG. 1, can also be integrated into the nexus engine 69, the event program 67 and/or the disposition program 66.

Program code, engines, and programs such as disposition program 66, event program 67, disposition allocation recommendation engine 68 and nexus engine 69 may be stored on at least one of one or more computer-readable tangible storage devices 830 shown in FIG. 2, on at least one of one or more portable computer-readable tangible storage devices 936 as shown in FIG. 2, or in a repository 53 connected to network 50, or may be downloaded to a device computer 52 or server computer 54, for use. For example, program code, engines and programs such as disposition program 66, event program 67, disposition allocation recommendation engine 68 and nexus engine 69 may be stored on at least one of one or more computer-readable tangible storage devices 830 on server computer 54 and downloaded to device computer 52 over network 50 for use.

Alternatively, server computer 54 can be a web server, and the program code, engines, and programs such as disposition program 66, event program 67, disposition allocation recommendation engine 68 and nexus engine 69 may be stored on at least one of the one or more computer-readable tangible storage devices 830 on server computer 54 and accessed device computer 52. In other exemplary embodiments, the program code, engines, and programs such as disposition program 66, event program 67, disposition allocation recommendation engine 68 and nexus engine 69 may be stored on at least one of one or more computer-readable storage devices 830 on device computer 52 or distributed between two or more servers.

In the depicted example, network data processing system 51 is the Internet with network 50 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 51 also may be implemented as a number of different types of networks, such as, for example, an intranet, local area network (LAN), or a wide area network (WAN). FIG. 1 is intended as an example, and not as an architectural limitation, for the different illustrative embodiments.

FIG. 2 illustrates internal and external components of a device computer 52 and server computer 54 in which illustrative embodiments may be implemented. In FIG. 2, a device computer 52 and a server computer 54 include respective sets of internal components 800a, 800b and external components 900a, 900b. Each of the sets of internal components 800a, 800b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828, disposition allocation recommendation engine 68 and nexus engine 69, and disposition program 66 and event program 67 are stored on one or more of the computer-readable tangible storage devices 830 for execution by one or more of the processors 820 via one or more of the RAMs 822 (which typically include cache memory). In the embodiment illustrated in FIG. 2, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and physical information.

Each set of internal components 800a, 800b also includes a R/W drive or interface 832 to read from and write to one or more portable computer-readable tangible storage devices 936 such as a CD-ROM, DVD, memory stick, magnetic tape, magnetic disk, optical disk or semiconductor storage device. Disposition allocation recommendation engine 68, nexus engine 69, disposition program 66 and event program 67 can be stored on one or more of the portable computer-readable tangible storage devices 936, read via R/W drive or interface 832 and loaded into computer-readable tangible storage devices 830.

Each set of internal components 800a, 800b also includes a network adapter or interface 836 such as a TCP/IP adapter card. Disposition allocation recommendation engine 68, nexus engine 69, disposition program 66, and event program 67 can be downloaded to the device computer 52 and server computer 54 from an external computer via a network (for example, the Internet, a local area network or other, wide area network) and network adapter or interface 836. From the network adapter or interface 836, disposition allocation recommendation engine 68, nexus engine 69, disposition program 66, and event program 67 are loaded into computer-readable tangible storage devices 830. Disposition allocation recommendation engine 68, nexus engine 69, disposition program 66, and event program 67 can be downloaded to the server computer 54 from an external computer via a network (for example, the Internet, a local area network or other, wide area network) and network adapter or interface 836. From the network adapter or interface 836, disposition allocation recommendation engine 68, nexus engine 69, disposition program 66, and event program 67 is loaded into hard drive 830. The network may comprise copper wires, optical fibers, wireless transmission, routers, firewalls, switches, gateway computers and/or edge servers.

Each of the sets of external components 900a, 900b includes a computer display monitor 920, a keyboard 930, and a computer mouse 934. Each of the sets of internal components 800a, 800b also includes device drivers 840 to interface to computer display monitor 920, keyboard 930 and computer mouse 934. The device drivers 840, R/W drive or interface 832 and network adapter or interface 836 comprise hardware and software (stored in computer-readable tangible storage devices 830 and/or ROM 824).

Disposition allocation recommendation engine 68, nexus engine 69, disposition program 66, and event program 67 can be written in various programming languages including low-level, high-level, object-oriented or non object-oriented languages. Alternatively, the functions of a disposition allocation recommendation engine 68, nexus engine 69, disposition program 66, and event program 67 can be implemented in whole or in part by computer circuits and other hardware (not shown).

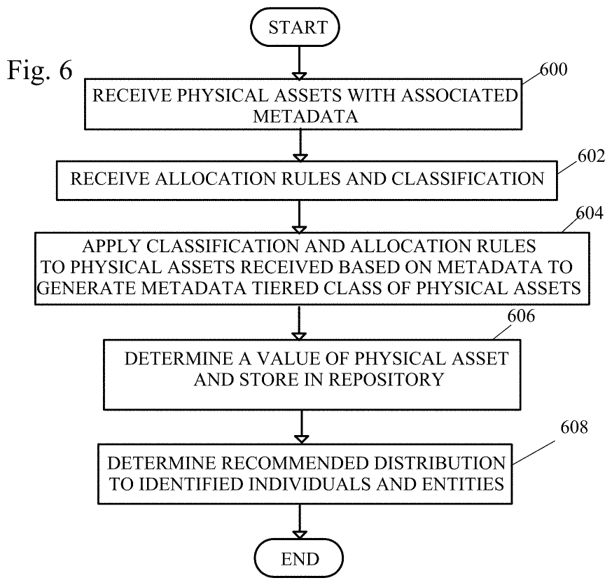

FIG. 6 shows a flow diagram of a method of receive and classifying physical assets of an owner of an embodiment.

In a first step, the disposition program 66 of the disposition system 71 receives a listing or catalogue of physical assets with associated metadata from an owner of the physical asset (step 600). The physical assets and associated metadata can be entered by the owner themselves or a third party at the direction of an owner.

In a preferred embodiment, the metadata includes images of the physical assets which can representative of condition of the physical asset and in some embodiments can be used to authenticate the brand, model and edition of the physical asset or other information that affects the valuation of the physical asset. The metadata can include a type of physical asset from categories set by the owner of predefined categories.

The metadata can also include information regarding who created the physical asset. For example, the metadata can include: the company that produced the physical asset; artist that created the physical asset; associated context associated with the artist, such as demand for the artist's work; whether the company is now out of business or not; or whether the artist will be producing additional works.

The metadata can also include provenance of the physical asset, where the physical asset was purchased, how much was paid for the physical asset, the brand associated with the physical asset, the edition of the physical asset, the physical condition of the physical asset, and repairs and maintenance carried out on the physical asset.

The metadata can additionally include a location of the physical asset including, but not limited to where the physical asset has been stored in a specific time period and whether the storage location had any effect on the condition of the physical asset. For example, storing an antique car in a temperature controlled facility versus outside and exposed to the elements.

The disposition program 66 receives allocation rules with classification criteria to be applied to the physical assets received (step 602). The allocation rules specifically dictate how the physical assets are to be allocated based on a possible event or a series of possible events designated by the owner. The allocation rules can include identification of a specific possible owner(s) of a physical asset, and importance of a physical asset to possible owner(s). Additionally, the allocation rules can designate whether the ownership should be transferred to new owner(s). The allocation rules can be a predetermined set of a rules, or based on a document, or a series of documents. For example, the document could be a contract or written agreement between an owner and a company in regards to a physical asset. In another example, the document could be the last will and testament of the owner. The classification criteria can include rules regarding the allocation of a certain type of physical asset.

In one embodiment, intellectual property could be transferred from a first company to at least a second company upon the formal signing of a sales agreement with allocation rules within the sales agreement designating the exact details of the transfer along with company holdings such as equipment, product with company branding, factories, buildings, etc.

Next, the allocation rules and associated classification criteria are applied by the disposition program 66 to the physical assets received based on metadata to generate a metadata tiered classification of physical assets received (step 604). In an embodiment of the present invention, the classification system of the physical assets is based on industry standards.

For example,
Company
   Properties
      Office Buildings
         Office equipment
         Furnishings
      Factories
      Storage Facilities
      Transportation Vehicles
   Product with branding
   Materials to continue production of goods
House
   Furniture
      Antiques
      Modern
   Paintings/Sculptures/Decorative
   Jewelry
   Clothing
   Vehicles
   Appliances
   Tools
   Miscellaneous Other Items
Intellectual Property
   Patents
   Trademarks

The disposition allocation recommendation engine 68 determines a value of the physical asset and stores the value in a secure or encrypted repository, for example repository 53 (step 606). In an alternate embodiment, the disposition program 66 can execute step 606. The value of the physical asset is calculated based on different references as well as the asset classification and metadata of the physical asset.

The valuation can be determined based solely on the metadata regarding the physical assets. For example, lookups of comparable value to other such physical assets which have been recently sold, e.g. mark to market value based on the qualifiers provided in the metadata. The metadata can also be used to determine condition and edition of the physical asset. If desired, the available metadata could be used to generate a formal appraisal from a qualified professional in the related space. Other methods for valuing the assets can be by reference schedules or a designated type or processing, such as, but not limited to generic schedules by asset class, auction comparisons and appraisals. The type of valuation can also include, but is not limited to, insurability, estate planning, high/low.

Based on the impartial value attributed to the physical assets as well as the allocation rules, the disposition allocation recommendation engine 68 determines a recommendation for distribution of the physical assets to individuals, group of individuals, entities or group of entities (step 608) and the method ends. The recommendation can include, but is not limited to: to whom a physical asset should be sent, to whom ownership is to be transferred (including any right to use permissions), a ranking of the individuals or entities to receive the physical assets, or if the physical asset should be destroyed or decommissioned.

In an alternate embodiment, prior to the method ending, a report regarding the identified individuals and entities, and value associated with the physical assets can be produced and sent to the owner, a third party and/or the identified individuals and entities. This information can assist a trusted individual in impartially allocating physical tangible assets.

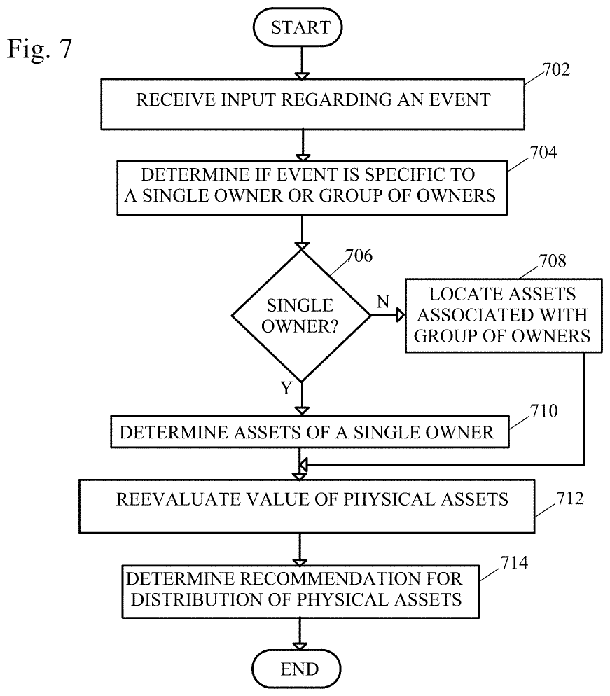

It should be noted that reevaluation of the value of the physical assets can take place based on events. FIG. 7 shows a flow diagram of a method of providing a disposition allocation recommendation based on an event.

In a first step, input regarding an event is received (step 702), for example by the disposition allocation recommendation engine 68 and/or the event program 67 via the data crawler 70. The input regarding the event may be received through manual input from the owner of the physical assets, a third party associated with the owner of the assets, such as an executor or an insurance claim, based on a predetermined schedule, or requested by the owner. Alternatively, the event may be received from a data crawler, such as data crawler 70 which monitors for, and analyzes public records to determine whether an event has occurred. The data crawler 70 can then feed data and associated context regarding an event(s) to the disposition allocation recommendation engine 68 and/or the event program 67. The event may be related to a single owner or multiple owners.

The disposition allocation recommendation engine 68 then determines if the event received is specific to a single owner or to a group of owners (step 704). The engine 68 can evaluate through machine learning and an associated training period what events may be relevant to only a single owner versus multiple or a group of owners. For example, natural disasters affecting output of a semi-precious gem may affect a group of owners of said gems in a specific geographic area.

If the disposition allocation recommendation engine 68 determines that the event received is associated with only a single owner (step 706), the engine 68 determines or locates the physical assets of the single owner affected by the event (step 710) and the method continues with step 712.

If the disposition allocation recommendation engine 68 determines that the event received is associated with a group of owners (step 706), the engine 68 determines or locates the physical assets of the group of owners affected by the event (step 708) and the method continues with step 712.

The disposition allocation recommendation engine 68 reevaluates the value of the physical asset based on the event and associated context, as well as the asset classification and metadata of the physical asset and stores the revaluation in the secure repository, such as repository 53 (step 712).

Based on the reevaluation of the value of the physical assets, the disposition allocation recommendation engine 68 determines a recommendation for distribution of the physical assets to individuals, groups of individuals, entities or groups of entities (step 714), and the method ends. The recommendation for distribution may be stored in the secure repository 53. Prior to the method ending, a report with the recommendation for distribution can be sent to the owner, a third party, or the individuals or entities to which the physical assets are to be distributed. The report can include data associated with the physical asset such as some or all of the metadata associated with each physical asset.

An example of a specific event designated by the owner of the physical assets to automatically initiate reevaluation of the physical assets is the sudden lack or ability to obtain a physical asset. For example, an owner with artwork by artist X could designate that the physical assets of the artwork by the artist X be reevaluated for an updated value when an event occurs in which artist X is no longer going to be producing art. In an alternate embodiment, the data crawler 70 could monitor for a trend in which specific editions of a physical assets are rereleased into the market, increasing the number of physical assets of an edition and thus decreasing the valuation associated with the physical asset held by the owner.

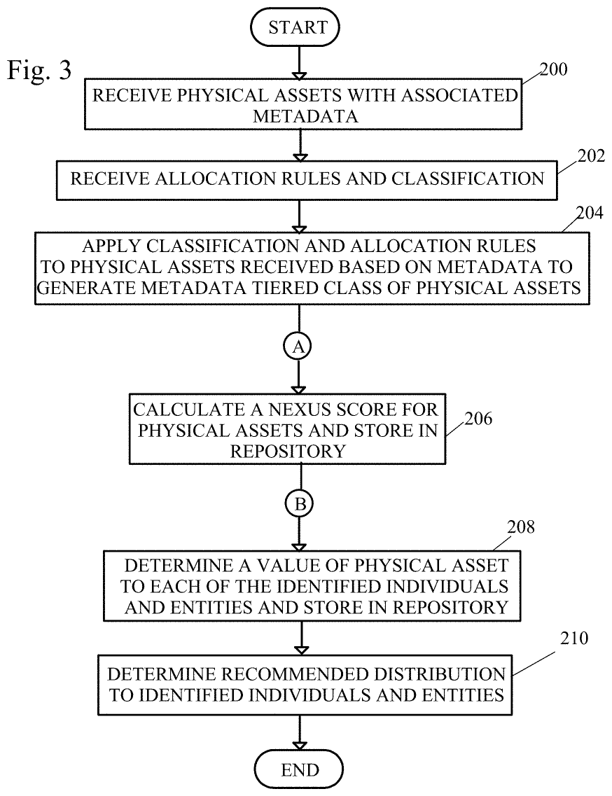

FIG. 3 shows a flow diagram of a method of receiving and classifying physical assets of an owner of an alternate embodiment.

In a first step, the disposition program 66 of the disposition system 71 receives a listing or catalogue of physical assets with associated metadata from an owner of the physical asset (step 200). The physical assets and associated metadata can be entered by the owner themselves or a third party at the direction of an owner. In an alternate embodiment, the owner can schedule the disposition program 66 and/or data crawler 70 to determine if any physical assets have been newly added or updated, removing the burden from the owner to manually enter any updates by the disposition program 66 and/or data crawler 70 by reviewing inventory logs, by reviewing money spent to acquire physical assets or initiating inventory to take place.

In a preferred embodiment, the metadata includes images of the physical assets which can be representative of the condition of the physical asset. In some embodiments the metadata can be used to authenticate the brand, model and edition of the physical asset or provide other information that affects the valuation of the physical asset. The metadata can include a type of physical asset from categories set by the owner of predefined categories.

The metadata can also include information regarding who created the physical asset. For example, the company that produced the physical asset or artist that created the physical asset as well associated context associated with the artist, such as demand for the artist's work, whether the company is still in business, or whether the artist will be producing additional works.

The metadata can also include provenance of the physical asset, where the physical asset was purchased, how much was paid for the physical asset, the brand associated with the physical asset, the edition of the physical asset, the physical condition of the physical asset, and repairs and maintenance carried out on the physical asset.

The metadata can additionally include a location of the physical asset including, but not limited to, where the physical asset has been stored during a specific time period, and whether the storage location had any effect on the condition of the physical asset. For example, storing an antique car in a temperature controlled facility versus outside and exposed to the elements.

The disposition program 66 receives allocation rules with classification criteria to be applied to the physical assets received (step 202). The allocation rules specifically dictate the manner in which the physical assets are to be allocated based on a possible event or a series of possible events designated by the owner. The allocation rules can include identification of a specific possible owner(s) of a physical asset, and the importance of a physical asset to possible owner(s). Additionally, the allocation rules can designate whether the ownership should be transferred to new owner(s). The allocation rules can be a preset set of a rules or based on a document or a series of documents.

Next, the allocation rules and associated classification criteria are applied by the disposition program 66 to the physical assets received based on metadata to generate a metadata tiered classification of physical assets received (step 204). In an embodiment of the present invention, the classification system of the physical assets is based on industry standards.

For example,
Company
   Properties
      Office Buildings
         Office equipment
         Furnishings
      Factories
      Storage Facilities
      Transportation Vehicles
   Product with branding
   Materials to continue production of goods
House
   Furniture
      Antiques
      Modern
   Paintings/Sculptures/Decorative
   Jewelry
   Clothing
   Vehicles
   Appliances
   Tools
   Miscellaneous Other Items
Intellectual Property
   Patents
   Trademarks

The nexus engine 69 of the disposition system 71 then calculates a nexus score for each physical asset and the nexus score is stored in a secure or encrypted repository, for example repository 53 (step 206). A nexus score is a numerical expression of the relative magnitude or affinity of a nexus between identified individuals and entities, other than the owner of the physical asset, to a physical asset. The nexus score is preferably calculated based on the metadata of the physical asset, the physical asset itself, indirect relationships of individuals or entities to the physical assets, nonobvious relationships of individuals or entities to the physical asset, and weights assigned by the owner of the physical asset.

The disposition allocation recommendation engine 68 determines a value of the physical asset to each of the identified individuals and entities and stores the value in secure or encrypted repository, for example repository 53 (step 208). In an alternate embodiment, the disposition program 66 can execute step 208. The value of the physical asset is calculated based on different references as well as the asset classification and metadata of the physical asset.

For example, using the metadata of the physical assets would allow for lookups of comparable value to other such physical assets which have been recently sold, e.g. mark to market value. The metadata can also be used to determine condition and edition of the physical asset. If desired, the available metadata could be used to generate a formal appraisal from a qualified professional in the related space. Other assets can be valued by reference schedules or a designated type or processing, such as, but not limited to, generic schedules by asset class, auction comparisons, and appraisals. The type of valuation can also include, but is not limited to, insurability, estate planning, high/low.

Based on the value of the physical assets and the associated nexus score, the disposition allocation recommendation engine 68 determines a recommendation for distribution of the physical assets to other individuals, group of individuals, entities or group of entities (step 210) and the method ends. The recommendation can include, but is not limited to: to whom a physical asset should be sent, to whom ownership is to be transferred (including any right to use permissions), a ranking of the individuals or entities to receive the physical assets, or if the physical asset should be destroyed or decommissioned.

In an alternate embodiment, prior to the method ending, a report regarding the nexus score, identified individuals and entities and value associated with the physical assets and sent to the owner, a third party and/or the identified individuals and entities. This information can assist a trusted individual in allocating physical tangible assets.

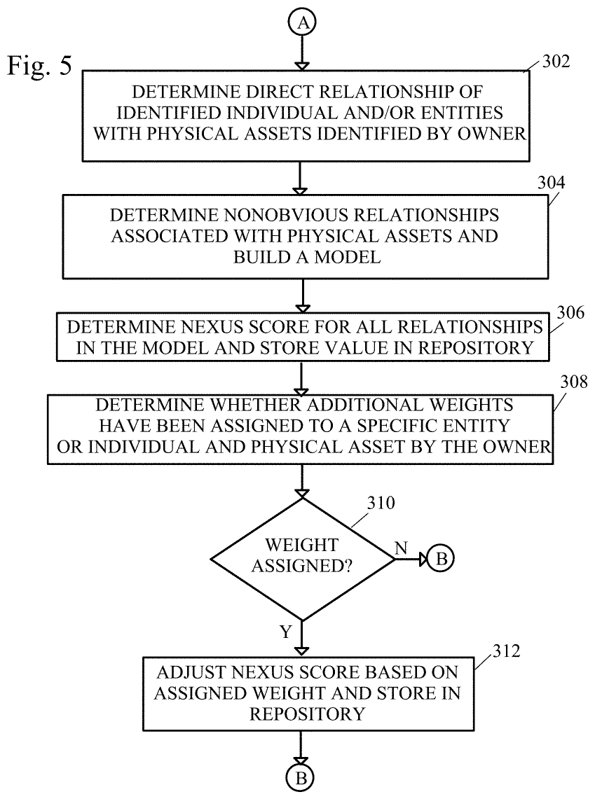

FIG. 5 shows a flow diagram of a method of step 208 of FIG. 3 of generating a nexus score.

In a first step, the nexus engine 69 determines direct relationships of individuals and/or entities with physical assets identified by owner (step 302). A direct relationship is defined as an individual, groups of individual, entity or group of entities which participated in creation of the physical asset, use of the physical asset, and/or monetary purchase of a physical asset.

The nexus engine 69 then determines nonobvious relationships associated with the physical assets based on data mining, for example via the data crawler 70 using nonobvious relationship awareness (NORA) and the metadata associated with the physical assets to build a model of identities and relationships of the identities associated with individuals and/or entities in real time (step 304). The model preferably includes both direct relationships and nonobvious relationships and can be associated with the nexus score. Cognitive analysis can also be used to determine interest in a physical asset by using the individuals present around or associated with, the physical asset to determine other physical assets created within a same time period or location with unidentified participants. The data crawler 70 mines data from published information, such as, but not limited to, published articles, published information regarding condition of a physical asset, inventory logs, receipts for purchase, deeds, social media feeds, blogs, forums, auctions, public databases, public records, published standards, and other information.

For each of the relationships of the model, the nexus engine 69 assigns a nexus score, and stores the value in a repository, such as secure repository 53 (step 306). The nexus score is a score of a value representative of a magnitude of affinity of an individual, group of individuals, entity or group of entities with a connection or a series of connections with a physical asset or an owner of a physical asset.

The nexus engine 69 then determines whether any additional weights have been assigned by the owner to a particular individual and/or entity with the physical asset (step 308). The weight may be added to either increase or decrease the magnitude of relationship with an individual and/or entity with a physical asset. For example, an increased weight may be added to an individual who may not have a direct relationship with a physical asset, but the owner has specific wishes towards.

If a weight has been assigned by the owner (step 310), based on the weight assigned, the nexus score is altered or adjusted by the nexus engine 69 and the updated nexus score is stored in the repository, for example secure repository 53 (step 312), and the method continues with step 208 of FIG. 3.

For example, if multiple persons may be interested in an antique glass cabinet—relatives of the family, a family friend which restored the glass cabinet, and a historical society which displays glass cabinets from the 1800s, the nexus engine can evaluate which entities may value the cabinet more, which takes into account relationships that are not predicated on the monetary value of the cabinet.

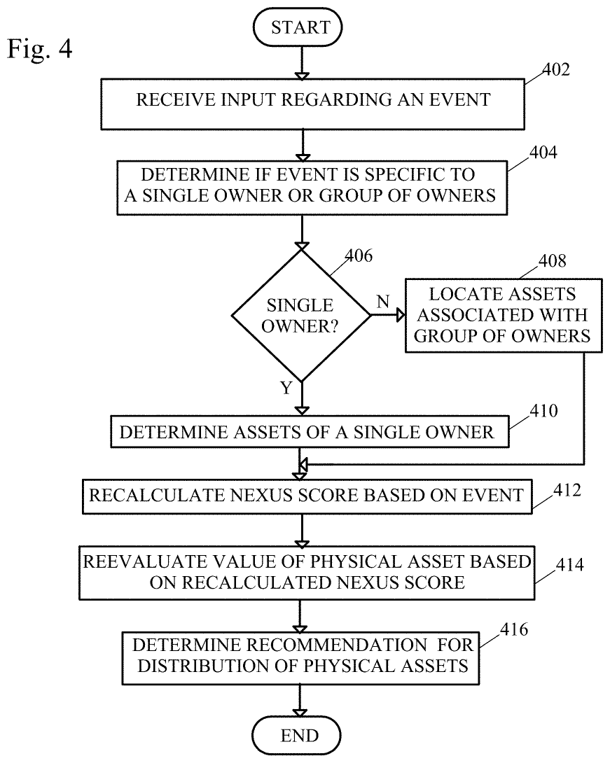

FIG. 4 shows a flow diagram of a method of providing a disposition allocation recommendation based on an event.

In a first step, input regarding an event is received (step 402), for example by the disposition allocation recommendation engine 68 and/or the event program 67. The input regarding the event may be received through manual input from the owner of the physical assets, a third party associated with the owner of the assets, such as an executor or an insurance claim, based on a predetermined schedule, or requested by the owner. Alternatively, the event may be received from a data crawler, such as data crawler 70 which monitors for and analyzes public records to determine whether an event has occurred. The data crawler 70 can then feed data regarding an event(s) to the disposition allocation recommendation engine 68 and/or the event program 67. The event may be related to a single owner or multiple owners.

The disposition allocation recommendation engine 68 then determines if the event received is specific to a single owner or to a group of owners (step 404). The engine 68 can evaluate through machine learning and an associated training period what events may be relevant to only a single owner versus multiple or a group of owners. For example, natural disasters may affect a group of owners in a specific geographic area, or there might be a contract between multiple parties.

If the disposition allocation recommendation engine 68 determines that the event received is associated with only a single owner (step 406), the engine 68 determines or locates the physical assets of the single owner affected by the event (step 410) and the method continues with step 412.

If the disposition allocation recommendation engine 68 determines that the event received is associated with a group of owners (step 406), the engine 68 determines or locates the physical assets of the group of owners affected by the event (step 408) and the method continues with step 412.

In step 412, the nexus score is recalculated based on the event and the recalculated nexus score is stored in the secure repository, such as repository 53 (step 412). The nexus score may be calculated by steps 302 through steps 312 of FIG. 5. The event may or may not influence a nexus score for a physical asset.

Next, the disposition allocation recommendation engine 68 reevaluates the value of the physical asset based on the recalculated nexus score and stores the revaluation in the secure repository, such as repository 53 (step 414). The value of the physical asset is calculated based on different references as well as the asset classification and metadata of the physical asset.

Based on the reevaluation of the value of the physical assets and the associated nexus score, the disposition allocation recommendation engine 68 determines a recommendation for distribution of the physical assets to individuals, groups of individuals, entities or groups of entities (step 416), and the method ends. The recommendation for distribution may be stored in the secure repository 53. Prior to the method ending, a report with the recommendation for distribution can be sent to the owner, a third party, or the individuals or entities to which the physical assets are to be distributed. The report can include data associated with the physical asset such as some or all of the metadata associated with each physical asset.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method of receiving and classifying physical assets of an owner comprising:
a computer receiving a catalogue of owned physical assets with associated metadata from the owner of the physical asset;
the computer receiving allocation rules with classification criteria to be applied to the owned physical assets of the catalogue, wherein the allocation rules include at least an identification of individuals and/or entities to receive at least one of the owned physical assets;
the computer applying allocation rules and classification criteria to the catalogue of physical assets received to generate a metadata tiered classification model of the physical assets;
the computer determining a value of each of the physical assets of the catalogue; and
the computer determining a recommendation for distribution of the physical assets to the identified individuals and entities other than the owner of the physical asset.

2. The method claim 1, wherein the value of the each of the physical assets of the catalogue is determined looking up comparable value of other such physical assets which have been recently sold based on the metadata.

3. The method of claim 1, wherein after applying allocation rules and classification criteria to the catalogue of physical assets received to generate a metadata tiered classification model of the physical assets, the computer calculating a nexus score for each physical asset representing a relative affinity of a nexus between identified individuals and entities other than the owner of the physical asset to the physical asset.

4. The method of claim 3, wherein calculating the nexus score comprises the computer:
determining direct relationships of identified potential new owners designated by the owner and associated with the physical asset;
determining nonobvious relationships associated with the physical asset;
building a model of the direct relationships and the nonobvious relationships associated with the physical asset;
assigning a score to the direct relationships and the nonobvious relationships of the model representative of the relative affinity of a nexus between identified individuals and entities other than the owner of the physical asset to the physical asset;
determining whether additional weight has been assigned to an identified identify or entity relative to the physical asset; and
altering the score for each additional weight assigned.

5. The method of claim 3, wherein the value of the physical asset is calculated based on reference schedules, asset classification and associated metadata, and the nexus score of the physical asset.

6. The method of claim 3, wherein the nonobvious relationships are determined through nonobvious relationship awareness and data mining.

7. The method of claim 1, wherein after the computer determining a recommendation for distribution of the physical assets to the identified individuals and entities other than the owner of the physical asset, the computer generating a report with the valuation and distribution of the physical assets to the identified individuals and entities other than the owner of the physical asset.

8. The method of claim 1, wherein the recommendation includes destruction or decommissioning of the physical asset.

9. The method of claim 1, wherein the recommendation includes to whom the physical asset can potentially belong to.

10. A method of determining a recommendation for allocation of a physical asset of an owner to identified individuals and entities other than the owner of the physical asset, based on an event which impacts a right to use the physical asset by the owner comprising:
a computer receiving input regarding the event;
the computer determining at least one physical asset affected by the event;
the computer reevaluating a value associated with the physical asset relative to the event; and
the computer determining a recommendation of distribution of the physical assets to the identified individuals and entities other than the owner of the physical asset.

11. The method claim 10, wherein the value of the each of the physical assets of the catalogue is determined looking up comparable value of other such physical assets which have been recently sold based on the metadata.

12. The method of claim 10, further comprising the computer calculating a nexus score representing a relative affinity of a nexus between the physical asset and the identified individuals and entities other than the owner of the physical asset.

13. The method of claim 12, wherein calculated the nexus score comprises:
determining direct relationships of potential new owners from the identified individuals and entities other than the owner of the physical asset designated by the owner and associated with the physical asset;
determining nonobvious relationships associated with the physical asset;
building a model of the direct relationships and the nonobvious relationships associated with the physical asset;
assigning a score to the direct relationships and the nonobvious relationships of the model representative of the relative affinity of a nexus between identified individuals and entities other than the owner of the physical asset to the physical asset;
determining whether additional weight has been assigned to an identified identify or entity relative to the physical asset; and
altering the score for each additional weight assigned.

14. The method of claim 13, wherein the nonobvious relationships are determined through nonobvious relationship awareness and data mining.

15. The method of claim 13, wherein the value of the physical asset is calculated based on reference schedules, asset classification and associated metadata, and the nexus score of the physical asset.

16. A computer program product for receiving and classifying physical assets of an owner with a computer comprising at least one processor, one or more memories, one or more computer readable storage media, the computer program product comprising a computer readable storage medium having program instructions embodied therewith, the program instructions executable by the computer to perform a method comprising:
receiving, by the computer, a catalogue of owned physical assets with associated metadata from the owner of the physical asset;
receiving, by the computer, allocation rules with classification criteria to be applied to the owned physical assets of the catalogue, wherein the allocation rules include at least an identification of individuals and/or entities to receive at least one of the owned physical assets;
applying, by the computer, allocation rules and classification criteria to the catalogue of physical assets received to generate a metadata tiered classification model of the physical assets;
determining, by the computer, a value of each of the physical assets of the catalogue; and
determining, by the computer, a recommendation for distribution of the physical assets to the identified individuals and entities other than the owner of the physical asset.

17. The computer program product of claim 16, wherein after applying allocation rules and classification criteria to the catalogue of physical assets received to generate a metadata tiered classification model of the physical assets, calculating, by the computer, a nexus score for each physical asset representing a relative affinity of a nexus between identified individuals and entities other than the owner of the physical asset to the physical asset.

18. The computer program product of claim 17, wherein calculating the nexus score comprises the computer:
determining direct relationships of identified potential new owners designated by the owner and associated with the physical asset;
determining nonobvious relationships associated with the physical asset;
building a model of the direct relationships and the nonobvious relationships associated with the physical asset;
assigning a score to the direct relationships and the nonobvious relationships of the model representative of the relative affinity of a nexus between identified individuals and entities other than the owner of the physical asset to the physical asset;
determining whether additional weight has been assigned to an identified identify or entity relative to the physical asset; and
altering the score for each additional weight assigned.

19. The computer program product of claim 16, wherein the value of the physical asset is calculated based on reference schedules, asset classification and associated metadata, and the nexus score of the physical asset.

20. The computer program product claim 16, wherein the value of the each of the physical assets of the catalogue is determined looking up comparable value of other such physical assets which have been recently sold based on the metadata.
